(19) United States
(12) Patent Application Publication
(10) Pub. No.: US 2019/0110308 A1
(43) Pub. Date: Apr. 11, 2019

(54) USER EQUIPMENT

(71) Applicant: NTT DOCOMO, INC., Tokyo (JP)

(72) Inventors: Shimpei Yasukawa, Tokyo (JP); Satoshi Nagata, Tokyo (JP); Qun Zhao, Beijing (CN)

(73) Assignee: NTT DOCOMO, INC., Tokyo (JP)

(21) Appl. No.: 16/088,431

(22) PCT Filed: Mar. 23, 2017
(86) PCT No.: PCT/JP2017/011708

§ 371 Date: Sep. 25, 2018

(30) Foreign Application Priority Data
Mar. 31, 2016 (JP) 2016-073456

(51) Int. Cl. H04W 72/12; H04W 72/04

(52) U.S. Cl. CPC H04W 72/1268; H04W 72/0486; H04W 72/0413; H04W 72/1236

(57) ABSTRACT

Provided is a user equipment including a transmission and reception unit that transmits and receives a radio signal to and from a base station, and a transmission plan notification unit that transmits, to the base station, an uplink data transmission plan related to a semi-persistent scheduling (SPS) configuration.

### TECHNICAL FIELD

The present invention relates to a radio communication system.

### BACKGROUND ART

In a current long term evolution (LET) system or an LTE-Advanced system, a semi-persistent scheduling (SPS) mode, in which a base station (evolved NodeB: eNB) periodically allocates a resource for uplink transmission by a user equipment (UE), is defined. The SPS mode is a resource allocation mode suitable for a situation in which uplink data periodically occurs in the user equipment.

### CITATION LIST

### Non-Patent Doucment

Non-Patent Document 1: TS 36.300, V8.12.0

### SUMMARY OF THE INVENTION

### Problem to be Solved by the Invention

However, in the SPS mode, even in a case where transmission target data is not present in the user equipment, a physical uplink shared channel (PUSCH) for uplink data transmission, is unnecessary allocated to the user equipment. The resource, which is allocated by the base station, is stationary. Accordingly, in a case where the user equipment includes the transmission target data exceeding an allocated resource, it is difficult for the user equipment to transmit the data at one transmission opportunity. In addition, the user equipment may desire to transmit the transmission target data at timing different from transmission timing that is set by the base station. It is difficult for the current SPS mode to effectively cope with the above-described case.

In addition, in current uplink data transmission, it is necessary for the user equipment to transmit a scheduling request, and a buffer status report. However, the transmission of the scheduling request and the buffer status report frequently causes a delay.

To solve the above-described problem, an object of the invention is to provide a technology capable of rapidly and efficiently transmitting uplink data.

### Means for Solving Problem

To solve the above-described problem, according to an aspect of the invention, there is provided user equipment including transmission and reception unit that transmits and receives a radio signal to and from a base station, and a transmission plan notification unit that transmits, to the base station, an uplink data transmission plan related to a semi-persistent scheduling (SPS) configuration.

According to another aspect of the invention, there is provided a user equipment including a transmission and reception unit that transmits and receives radio signal to and from a base station, and a scheduling request transmission unit that transmits a scheduling request to the base station in combination with a size of transmission target data.

### Effect of the Invention

According to the aspect of the invention, it is possible to provide a technology of rapidly and efficiently transmitting uplink data.

### BRIEF DESCRIPTION OF DRAWINGS

FIG. 1 is a schematic view illustrating a radio communication system according to an example of the invention;

FIG. 2 is a block diagram illustrating a hardware configuration of a user equipment according to the example of the invention;

FIG. 3 is a block diagram illustrating a hardware configuration of a base station according to the example of the invention;

FIG. 4 is a block diagram illustrating a functional configuration of the user equipment according to the example of the invention;

FIG. 5 is a sequence diagram illustrating uplink SPS transmission according to the example of the invention;

FIG. 6 is a schematic view illustrating transmission timing of a transmission plan according to the example of the invention;

FIG. 7 is a schematic view illustrating transmission timing of a transmission plan according to another example of the invention;

FIG. 8 is a schematic view illustrating a PUCCH format for transmission of a transmission plan according to the example of the invention.

FIG. 9 is a schematic view illustrating transmission of the transmission plan according to the example of the invention;

FIG. 10 is a schematic view illustrating transmission of the transmission plan according to the other example of the invention;

FIG. 11 is a schematic view illustrating a PUCCH format for transmission of the transmission plan according to the other example of the invention;

FIG. 12 is a block diagram illustrating a functional configuration of a user equipment according to still another example of the invention;

FIG. 13 is a sequence diagram illustrating processing of transmitting a scheduling request in combination with a simplified buffer status report according to the other example of the invention;

FIG. 14 is a schematic view illustrating a PUCCH format for transmission, of the scheduling request according to the other example of the invention; and

FIG. 15 is a block diagram illustrating hardware configurations of a user equipment and a base station according to the example of the invention;

### MODE (S) FOR CARRYING OUT THE INVENTION

Hereinafter, an embodiment of the invention will be described with reference to the accompanying drawings,

In an example to be described below, a user equipment capable of rapidly and efficiently transmitting uplink data is disclosed. In the following example, in a communication mode in which a data transmission opportunity such as an SPS configuration is periodically allocated, the user equipment notifies a base station of a transmission plan (transmits, to a base station, a transmission plan) including presence or absence of transmission target data, and a size of the transmission target data before transmitting the uplink data. According to this, the base station can reallocate a resource on the basis of the transmission plan that is received. In addition, in another example, the user equipment transmits a scheduling request in combination with a simplified buffer status report indicating whether or not a size of the transmission target data is equal to or greater than a predetermined size. According to this, the base station can allocate an appropriate resource on the basis of the simplified buffer status report that is received.

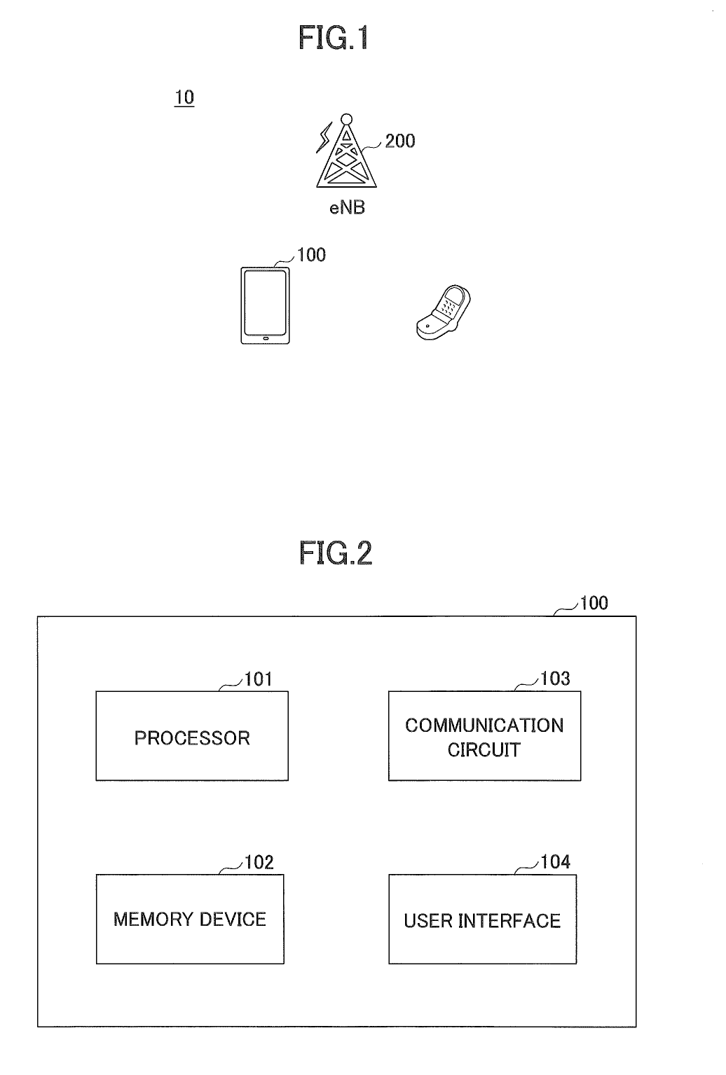

First, description will be given of a radio communication system according to the example of the invention with reference to FIG. 1. FIG. 1 is a schematic view illustrating a radio communication system according to the example of the invention.

As illustrated in FIG. 1, a radio communication system 10 includes a user equipment 100 and a base station 200. For example, the radio communication system 10 is a radio communication system conforming to a standard according to a 3^{rd} generation partnership project (3GPP) such as an LTE system, an LE-advanced system, and a 5G system. In the example in the drawing, only one base station 200 is illustrated, but a plurality of the base stations 200 are disposed to cover a service area of the radio communication system 10.

The user equipment (UE) 100 transmits and receives a radio signal to and from the base station 200 through a cell that is provided by the base station 200. Typically, as illustrated in the drawing, the user equipment 100 may be any appropriate information processing apparatus such as a smartphone, a portable telephone, a tablet, a mobile router, and a wearable terminal which are provided with a radio communication function. In addition, the user equipment 100 may be provided with a device-to-device (D2D) function capable of performing a communication with another user equipment 100 without through the base station 200.

As illustrated in FIG. 2, the user equipment 100 is constituted by hardware resources such as a processor 101 that functions as a central processing unit (CPU), a memory device 102 such as a random access memory (RAM) and a flash memory, a communication circuit 103 that transmits and receives a radio signal to and from the base station 200, an user interface 104 such as an input and output device and a peripheral device, and the like. For example, each function and each kind of processing of the user equipment 100 to be described later may be realized through processing or execution of data or a program, which is stored in the memory device 102, by the processor 101. However, the user equipment 100 is not limited to the above-described hardware configuration, and may be constituted by a circuit that realizes one or more kinds of processing to be described later, and the like.

The base station (eNS) 200 is wirelessly connected to the user equipment 100 to transmit a downlink (DL) packet received from a higher station or a server that is communicatively connected to a core network (not illustrated) to the user equipment 100, and transmits an uplink (UL) packet received from the user equipment 100 to a server.

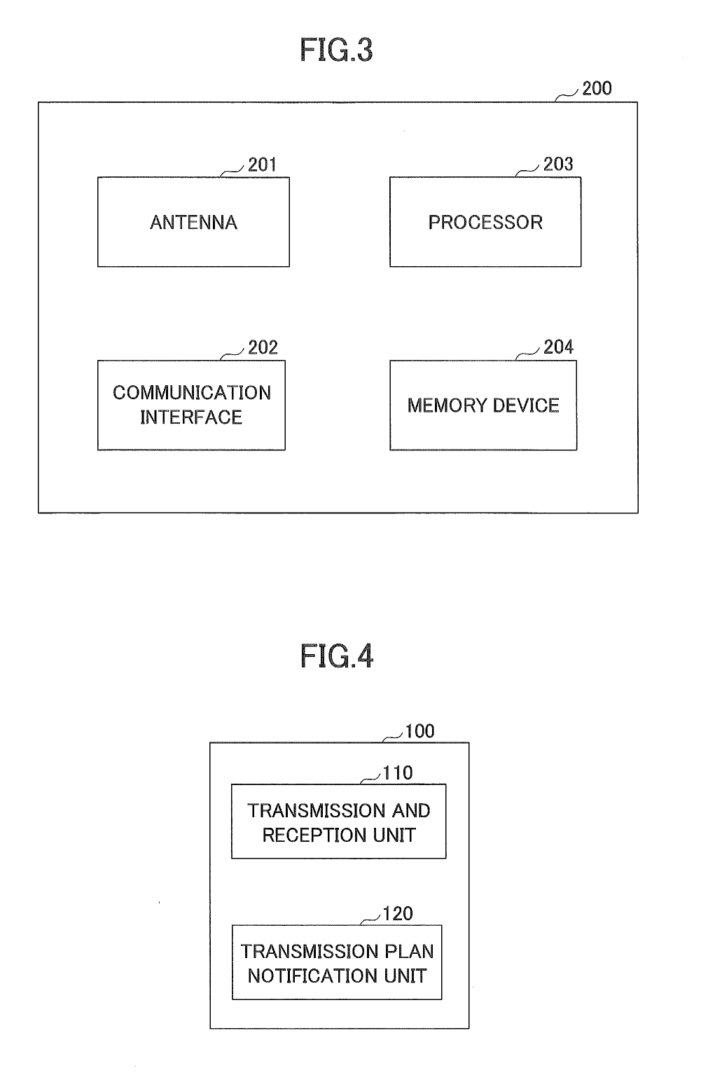

As illustrated in FIG. 3, typically, the base station 200 is constituted by hardware resources such as an antenna 201 that transmits and receive a radio signal to and from the user equipment 100, a communication interface 202 including an X2 interface for a communication with an adjacent base station 200 and an S1 interface for a communication with the core network (not illustrated), a processor 203 that processes a signal that is transmitted to and received from the user equipment 100, and a memory device 204. Each function and each kind of processing of the base station 200 to be described later may be realized through processing or execution of data or a program, which is stored in the memory device 204, by the processor 203. However, the base station 200 is not limited to the above-described hardware configuration and may have any appropriate hardware configuration.

Next, description will be given of the user equipment according to the example of the invention with reference to FIG. 4. FIG. 4 is a block diagram illustrating a functional configuration of the user equipment according to the example of the invention.

As illustrated in FIG. 4, the user equipment 100 includes a transmission and reception unit 110, and a transmission plan notification unit 120.

The transmission and reception unit 110 transmits and receives a radio signal to and from the base station 200. Specifically, the transmission and reception unit 110 transmits and receives various kinds of radio channels such as an uplink/downlink control channel and an uplink/downlink data channel to and from the base station 200. For example, in an uplink SPS communication, the transmission and reception unit 110 periodically transmits a control signal and a data signal to the base station 200 by a physical uplink control channel (PUCCH) and a physical uplink shared channel (PUSCH) in accordance with an SPS configuration that is set by the base station 200.

In addition, in the D2D communication, the transmission and reception unit 110 transmits and receives a control signal and a data signal to and from another user equipment 100 without through the base station 200. For example, on a transmission side, the transmission and reception unit 110 transmits the control signal and the data signal to the other user equipment 100 by a physical sidelink system channel (PSCCH) and a physical sidelink shared channel.

The transmission plan notification unit 120 transmits, to the base station 200, an uplink data transmission plan related to the SPS configuration. Specifically, when the SPS configuration, in which an uplink data transmission resource is periodically allocated to the user equipment 100, is set, the transmission plan notification unit 120 reports the uplink data transmission plan in each transmission opportunity (subframe) to the base station 200. Here, the transmission plan notification unit 120 transmits, to the base station 200, the transmission plan by the PUCCH before uplink data transmission timing. Furthermore, the invention may be applied to any communication mode in which the data transmission opportunity is periodically allocated without limitation to the SPS configuration. In addition, the transmission plan according to the invention is not limited to the transmission by the PUCCH, and transmission may be conducted by any appropriate resource or in any appropriate transmission opportunity.

In the example, the transmission plan may include a plan in which transmission target data does not present, a plan in which the transmission target data is present, and a plan in which one or more of a size of the transmission target data, and an offset of transmission timing are included. For example, when the user equipment 100 does not include transmission target uplink data in an arbitrary transmission opportunity (subframe), the transmission plan notification unit 120 reports “absence of transmission target data” to the base station 200. In addition, when the user equipment 100 includes the transmission target uplink data in an arbitrary transmission opportunity, the transmission plan notification unit 120 reports “presence of transmission target data” to the base station 200. In addition, when the user equipment 100 includes transmission target uplink data in an arbitrary transmission opportunity, the transmission plan notification unit 120 may transmits, to the base station 200, “size of transmission target data”. In addition, when the user equipment 100 desires to vary transmission timing, which is set in arbitrary transmission opportunity, by an arbitrary time offset, the transmission plan notification unit 120 may transmits, to the base station 200, “offset of transmission timing”. When receiving the transmission plan, the base station 200 can recognize presence or absence of the transmission data from the user equipment 100, or can transmits, to the user equipment 100, an uplink grant indicating a new resource correspond to the data size or the offset that is transmitted in the transmission. In this manner, the base station 200 can appropriately correct a resource, which is set according to the SPS configuration, in accordance with the transmission plan that is reported from the user equipment 100, and it is possible to realize a flexible SPS mode corresponding to transmission needs in the user equipment 100.

For example, in a case where the user equipment 100 reports “absence of transmission target data in an arbitrary subframe” to the base station 200, the base station 200 can reallocate the PUSCH, which is originally set according to the SPS configuration, to another resource. In an SPS mode of the related art, even when transmission target data is not present, the user equipment 100 transmits dummy data such as zero padding in a PUSCH that is originally set. However, in this example, the user equipment 100 can skip transmission in a subframe in which the transmission target data is not present. According to this, it is possible to avoid power consumption and occurrence of interference due to unnecessary transmission.

The transmission plan may be transmitted as a report relating to the entirety of semi-static transmission resources after notification of the transmission plan instead of a report relating to transmission in each transmission opportunity (subframe). For example, it is possible to activate or de-activate the SPS configuration on the basis of transmission of the transmission plan. Here, activation or de-activation may be valid in response to transmission of the transmission plan from a terminal. In addition, the SPS configuration may be activated or de-activated for the first time when a signaling response is received from a base station. In the former case, reliability of signaling is low, and thus status mismatching between the terminal and the base station may occur, but a signaling overhead is small. In the latter case, the reliability of signaling is high, but the overhead is large, and is not suitable for highly frequent activation or de-activation.

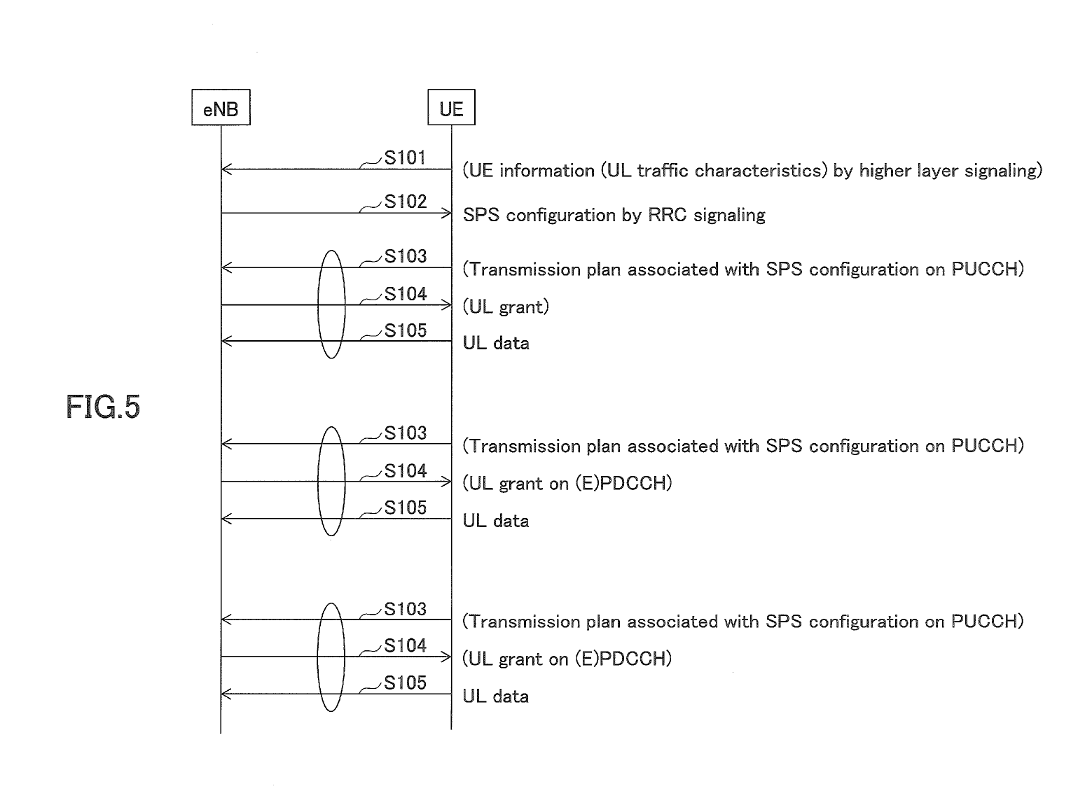

FIG. 5 is a sequence diagram illustrating the uplink SPS transmission according to the example of the invention. As illustrated in FIG. 5, in step S101, the transmission and reception unit 110 transmits, to the base station 200, an uplink traffic characteristic. For example, the uplink traffic characteristic may include transmission cycle, a packet size for each transmission, a priority, and the like, and the base station 200 may be notified of the uplink traffic characteristic by higher layer signaling.

In step S102, when receiving the uplink traffic characteristic, the base station 200 sets an SPS configuration suitable for the uplink traffic characteristic that is received, and transmits, to the user equipment 100, the SPS configuration by radio resource control (RRC) signaling. For example, the SPS configuration represents resources such as a PUSCH and a PUCCH which are allocated to the user equipment 100 for uplink transmission.

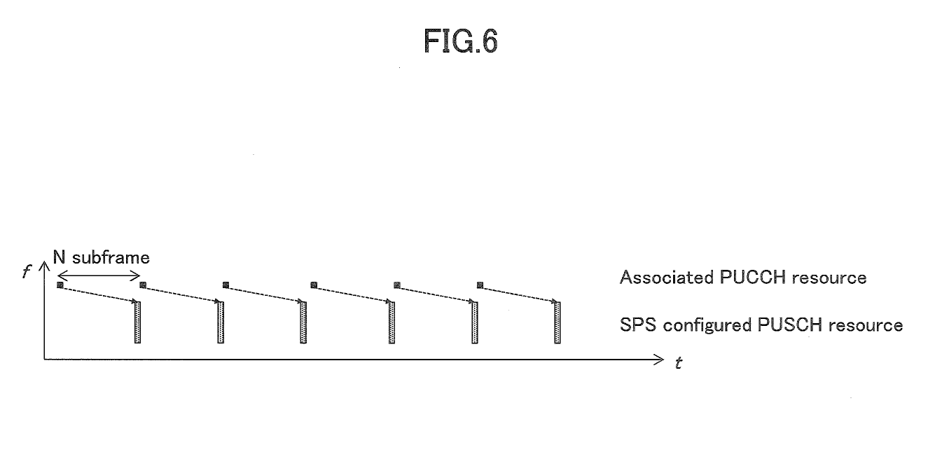

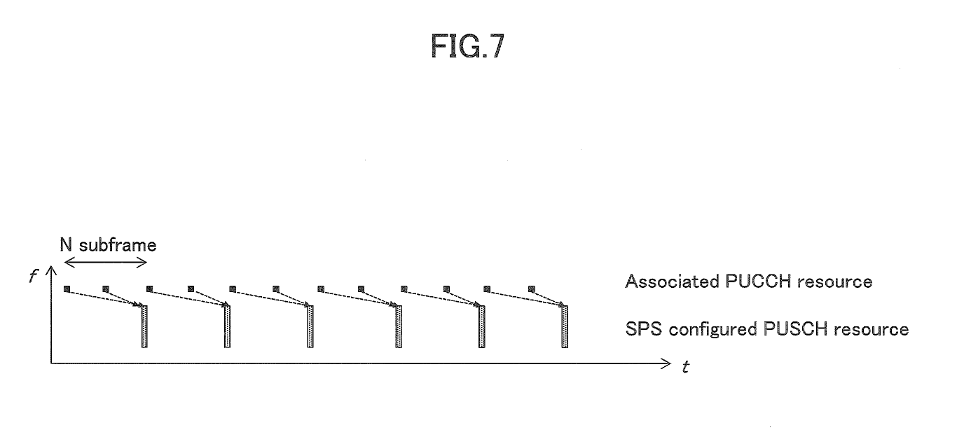

In step S103, in a PUCCH that is set by a higher layer and/or a PUCCH related to a PUSCH that is allocated according to the SPS configuration, the transmission plan notification unit 120 transmits, to the base station 200, the transmission plan. Specifically, the PUCCH for notification of the transmission plan may be a resource that immediately precedes a PUSCH allocated according to the SPS configuration, a resource that precedes the PUSCH allocated according to the SPS configuration by N subframes, a resource within N subframes from the PUSCH allocated according to the SPS configuration, and the like. For example, as illustrated in FIG. 6, the transmission plan notification unit 120 may transmits the transmission plan to the base station 200 before N subframes of the PUSCH that is allocated according to the SPS configuration. Alternatively, as illustrated in FIG. 7, the transmission plan notification unit 120 may transmits the transmission plan to the base station 200 within N preceding subframes from the PUSCH allocated according to the SPS configuration. In this case, as illustrated in the drawing, the transmission plan notification unit 120 may transmit the transmission plan a plurality of times.

In step S104, the base station 200 confirms the transmission plan that is received, and may make a notification of an uplink grant, which corresponds to the transmission plan, as necessary. For example, in a case where the transmission plan represents “size of transmission target data” or “offset of transmission timing”, the base station 200 may transmit an uplink grant, which corresponds to the “size of transmission target data” or the “offset of transmission timing” which is transmitted in the notification, to the user equipment 100.

In step S105, the transmission and reception unit 110 transmits uplink data by the PUSCH allocated according to the SPS configuration or a PUSCH that is allocated according to the uplink grant that is received in step S104.

Then, as illustrated in the drawing, the user equipment 100 repeats step S103 to step S105 as described above.

In the above-described example, when the transmission target data is not present in the user equipment 100, the transmission plan notification unit 120 transmits, to the base station 200, “absence of transmission target data” as the transmission plan. However, the notification of “absence of transmission target data” is not limited thereto. For example, transmission or reception in the user equipment 100 has a relatively higher priority in comparison to transmission of uplink data to the base station 200 in a corresponding subframe, the transmission plan notification unit 120 may transmits, to the base station 200, “absence of transmission target data”. In this case, even when the user equipment 100 has transmission target data in a buffer, the transmission and reception unit 110 does not transmit uplink data to the base station 200 in the subframe.

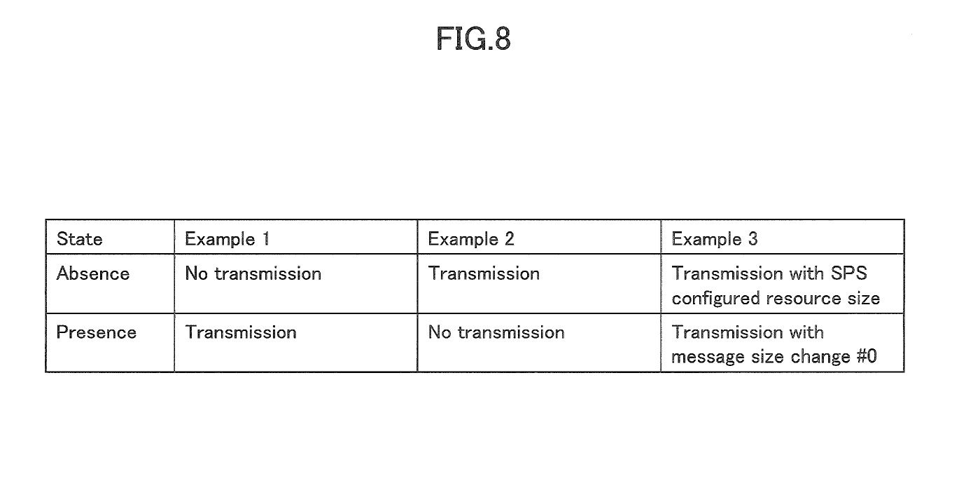

Next, description will be given of a PUCCH format for transmission of the transmission plan in accordance with various examples of the invention with reference to FIG. 8 to FIG. 11. The PUCCH format to be described later transmits the above-described transmission plan by citing an existing PUCCH format.

FIG. 8 is a schematic view illustrating the PUCCH format for transmission of the transmission plan according to an example of the invention. In the example illustrated in FIG. 8, a PUCCH format 1/1a is cited, and the transmission plan notification unit 120 may make a notification of arbitrary two among “absence of transmission target data”, “presence of transmission target data”, “size of transmission target data”, and “offset of transmission timing” in accordance with transmission or non-transmission of transmission of a PUCCH that is set.

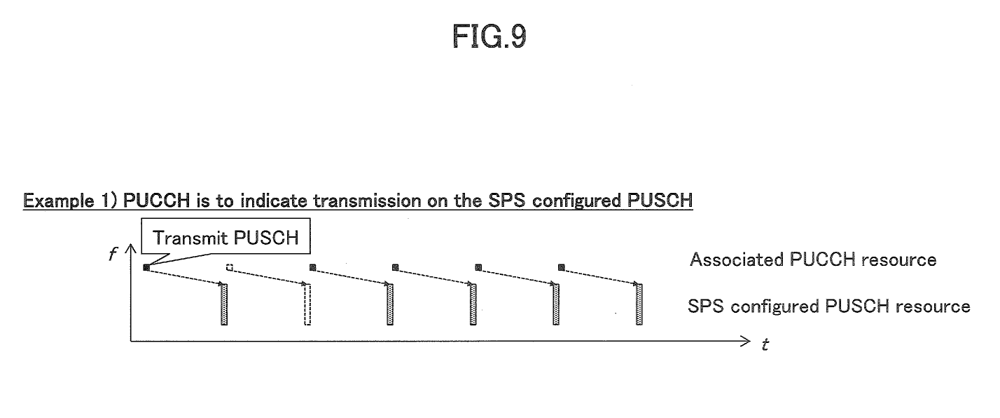

As illustrated in FIG. 8, in Specific Example 1, the PUCCH is not transmitted for notification of “absence of transmission target data”, and the PUCCH is transmitted for notification of “presence of transmission target data”. That is, in a case where transmission target data is not present in the user equipment 100, or in a case where the user equipment 100 gives a priority to another transmission and reception, as illustrated in FIG. 9, the transmission plan notification unit 120 does not transmit the PUCCH before transmission of the PUSCH allocated according to the SPS configuration. In a case of not receiving the PUCCH before the PUSCH that is allocated, the base station 200 determines that “transmission target data is not present” in the user equipment 100. In this case, the base station 200 may reallocate the PUSCH to another user equipment 100. On the other hand, in a case where transmission target data is present in the user equipment 100, as illustrated in FIG. 9, the transmission plan notification unit 120 transmits the PUCCH before transmission of the PUSCH allocated according to the SPS configuration. In a case of receiving the PUCCH before the PUSCH that is allocated, the base station 200 determines that “transmission target data is present” in the user equipment 100. Specific Example 1 is suitable for a case in which a typical status of the user equipment 100 corresponds to “transmission target data is not present” from the viewpoint of avoiding occurrence of interference.

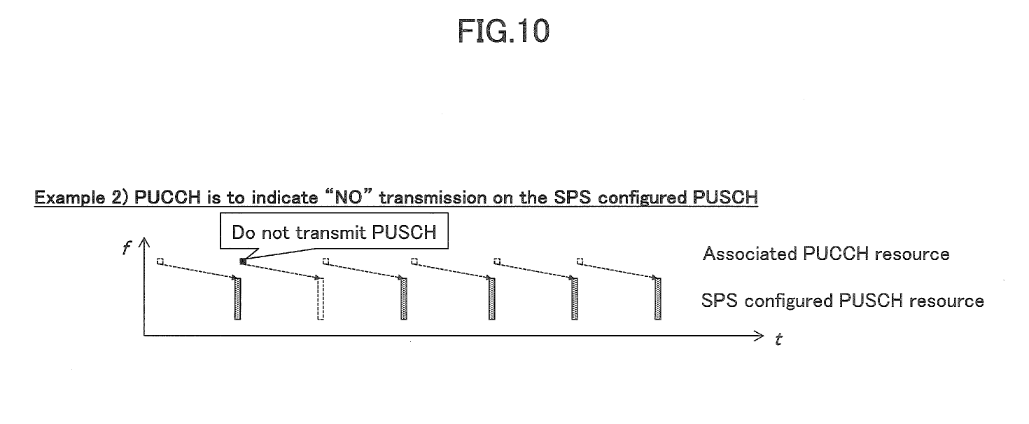

On the other hand, in Specific Example 2, the PUCCH is not transmitted for notification of “presence of transmission target data”, and the PUCCH is transmitted for notification of “absence of transmission target data”. That is, in a case where transmission target data is present in the user equipment 100, as illustrated in FIG. 10, the transmission plan notification unit 120 does not transmit the PUCCH before transmission of the PUSCH that is allocated according to the SPS configuration. In a case of not receiving the PUCCH before the PUSCH that is allocated, the base station 200 determines that “transmission target data is present” in the user equipment 100, and waits for uplink data from the user equipment 100. On the other hand, in a case where transmission target data is not present in the user equipment 100, as illustrated in FIG. 10, the transmission plan notification unit 120 transmits the PUCCH before transmission of the PUSCH that is allocated according to the SPS configuration. In a case of receiving the PUCCH before the PUSCH that is allocated, the base station 200 determines that “transmission target data is not present” in the user equipment 100. In this case, the base station 200 may reallocate the PUSCH to another user equipment 100. Specific Example 2 is suitable for a case in which the status of the typical user equipment 100 corresponds to “presence of transmission target data” from the viewpoint of avoiding occurrence of interference. In addition. Specific Example 3 can be used to make a request for changing of “size of transmission target data” in accordance with transmission or non-transmission of the PUCCH. In Specific Example 3, the transmission plan notification unit 120 transmits the PUCCH for notification of a request for changing of the “size of transmission target data”. Typically, in a case where transmission target data in the user equipment 100 exceeds a resource size of the PUSCH that is allocated according to the SPS configuration, the transmission plan notification unit 120 transmits the PUCCH to make a request for changing of the “size of transmission target data). In a case of receiving the PUCCH before the PUSCH that is allocated, the base station 200 determines that the user equipment 100 makes a request for changing of the “size of transmission target data”, and may reallocate a PUSCH in which only a predetermined size is incremented as an example. On the other hand, the PUCCH may not be transmitted for notification of uplink data transmission by the user equipment 100 in accordance with a resource size of the PUSCH that is allocated according to the SPS configuration that is originally set.

Furthermore, in the above-described specific example, the base station 200 may allocate the same PUCCH resource (time/frequency/symbol) to a plurality of the user equipments 100 so as to reduce a PUCCH overhead. In addition, the respective specific examples may be switched to each other. For example, the base station 200 may make a notification, which indicates which specific example is applied, by RRC signaling.

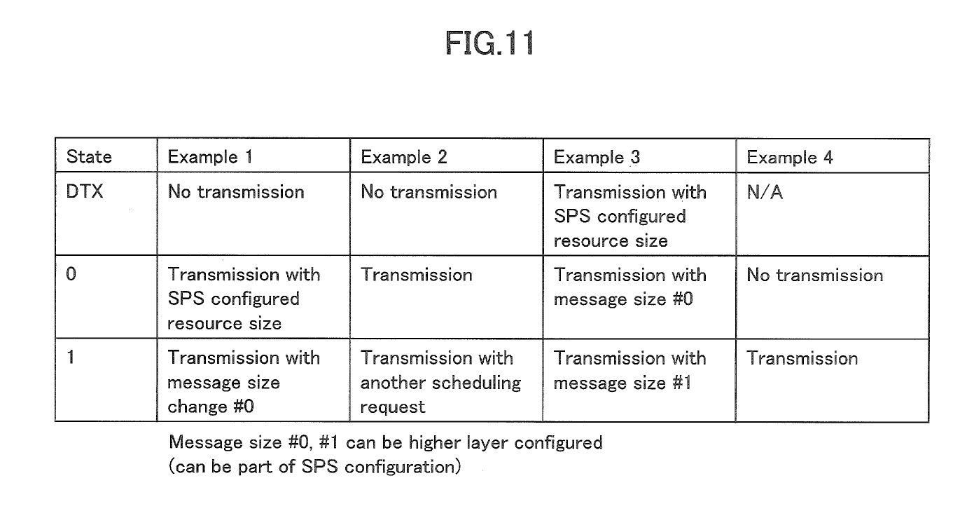

FIG. 11 is a schematic view illustrating a PUCCH format for transmission of a transmission plan according to another example of the invention. In the example illustrated m FIG. 11, the PUCCH format 1/1a is also cited, and the transmission plan notification unit 120 may make a notification of arbitrary three or greater among “absence of transmission target data”, “presence of transmission target data”, “size of transmission target data”, and “offset of transmission timing” in accordance with transmission or non-transmission of a PUCCH that is set and transmission contents.

As illustrated in FIG. 11, in Specific Example 1, the PUCCH is not transmitted for notification of “absence of transmission target data”. In addition, a PUCCH of a bit value of “0” is transmitted for notification of no change in “size of transmission target data” in addition to “presence of transmission target data”. In addition, a PUCCH of a bit value of “1” is transmitted for notification of a request for changing of the “size of the transmission target data in addition to “presence of transmission target data”.

In addition, Specific Example 2, the PUCCH is not transmitted for notification of “absence of transmission target data”. In addition, a PUCCH of a bit value of “0” is transmitted for notification of “presence of transmission target data”. In addition, a PUCCH of a bit value of “1” is transmitted for notification of a request for “new scheduling request” in addition to “presence of transmission target data”. In a case of receiving the PUCCH of a bit value of “1” before the PUSCH that is allocated, the base station 200 may reset the SPS configuration, or may stop the SPS configuration and dynamically allocate a resource.

In addition, in Specific Example 3, the PUCCH is not transmitted for notification of no change in the “size of transmission target data” in addition to “presence of transmission target data”. In addition, a PUCCH of a bit value of “0” is transmitted to make a request for change of the “size of transmission target data” into a message size #0 in addition to “presence of transmission target data”. In addition, a PUCCH of a bit value of “1” is transmitted to make a request for change of the “size of transmission target data” into a message size #1 in addition to “presence of transmission target, data”. Here, the message sizes #0 and #1 are different from each other, and may be set in a higher layer by the base station 200, or may be set as a part of the SPS configuration. For example, in a case where the transmission target data in the user equipment 100 exceeds a resource size of the PUSCH that is allocated according to the SPS configuration, the transmission plan notification unit 120 may transmit a PUCCH of a bit value of “0” or “1” in correspondence with a necessary message size. In a case of receiving the PUCCH of a bit value of “0” or “1” before the PUSCH that is allocated, the base station 200 may reset the SPS configuration in correspondence with the message size that is transmitted in notification, or may stop the SPS configuration and dynamically allocate a resource.

In addition, in Specific Example 4, the PUCCH is set to be transmitted and a PUCCH of a bit value of “0” is transmitted for notification of “absence of transmission target data”, and a PUCCH of a bit value of “1” is transmitted for notification of “presence of transmission target data”.

In the same manner, it should be easily understood by those skilled in the art that the transmission plan notification unit 120 can make a notification of any one of “absence of transmission target data”, “presence of transmission target data”, “size of transmission target data”, and “offset of transmission timing” in accordance with transmission or non-transmission of the PUCCH that is set, and/or transmission contents. That is, the transmission plan notification unit 120 may make a notification of any one or more of “absence of transmission target data”, “presence of transmission target data”, “size of transmission target data”, and “offset of transmission timing” in accordance with transmission or non-transmission of the PUCCH that is set, and/or transmission contents.

Furthermore, in the above-described specific examples, the base station 200 may allocate the same PUCCH resource (time/frequency/symbol) to a plurality of the user equipments 100 so as to reduce a PUCCH overhead. In addition, the respective specific examples may be switched to each other. For example, the base station 200 may make a notification, which indicates which specific example is applied, by RRC signaling. A part of an existing scheduling request (PUCCH) transmission resource may be used in the PUCCH signaling. For example, before N subframes of a resource that is allocated according to the SPS configuration or in a constant subframe section, the scheduling request of the related art is not transmitted and is used in the report of the transmission plan, and the base station may switch identification of the PUCCH in accordance with a subframe that is received.

In addition, in the above-described examples, the PUCCH format 1/1a is used. However, the invention is not limited thereto, and may reuse another PUCCH format. For example, a PUCCH format other than a PUCCH format having a relatively great payload size may be cited, and the transmission plan notification unit 120 may make a notification of three or greater transmission plans. The notification may be made by a higher layer signaling so as to report great pieces of information.

In the above-described examples, description has been given of a configuration in which the PUCCH signaling of the transmission plan is used in the SPS communication. However, the PUCCH signaling of the transmission plan in the invention is not limited thereto, and may be used, for example, in a D2D communication. In this case, the transmission plan notification unit 120 transmits, to the base station 200, the transmission plan in the PUCCH, and transmit control information and data, for example, in the physical sidelink control channel (PSCCH) and the physical sidelink shared channel (PSSCH) in accordance with the transmission plan or signaling from the base station 200.

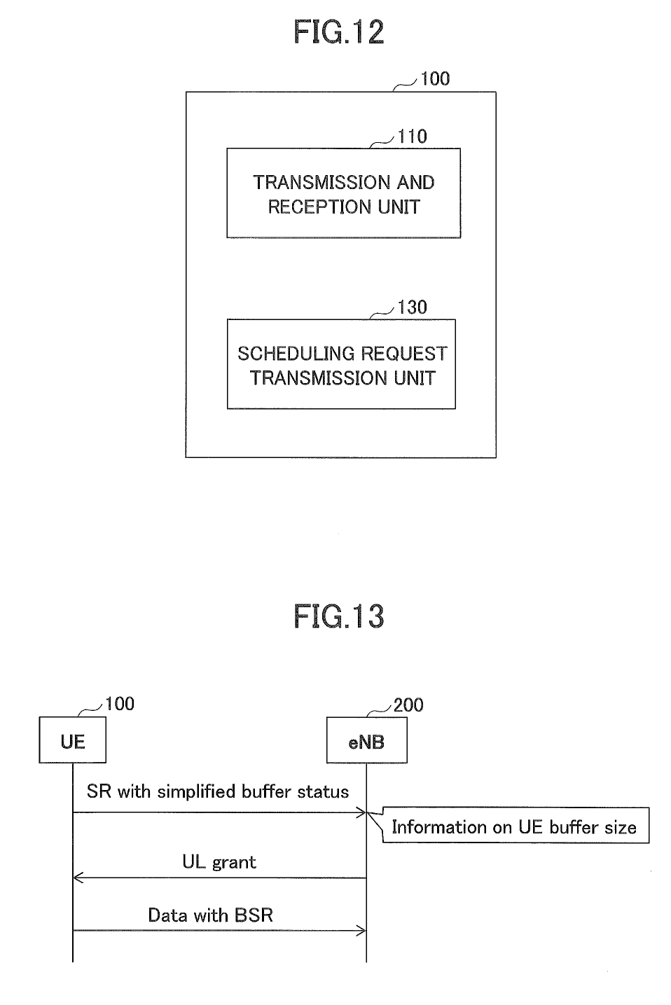

Next, description will be given of a user equipment according to still another example of the invention with reference to FIG. 12. In this example, when the user equipment 100 transmits a scheduling request to the base station 200, the user equipment 100 transmits the scheduling request to the base station 200 in combination with a simplified buffer status such as a size of transmission target data.

FIG. 12 is a block diagram illustrating a functional configuration of the user equipment according to the other example of the invention. As illustrated in FIG. 12, the user equipment 100 includes a transmission and reception unit 110 and a scheduling request transmission unit 130. The transmission and reception unit 110 according to this example is the same as the transmission and reception unit 110 in the above-described examples, and thus description thereof will be omitted.

The scheduling request transmission unit 130 transmits a scheduling request to the base station 200 in combination with a size of transmission target data. Specifically, as illustrated in FIG. 13, the scheduling request transmission unit 130 transmits the scheduling request to the base station 200 in combination with a simplified buffer status report. For example, the simplified buffer status report may be “size of transmission target data is less than a predetermined buffer size”, “size of transmission target data is equal to or greater than a predetermined buffer size”, and the like. In this case, the scheduling request transmission unit 130 may transmit the scheduling request to the base station 200 in combination with the size of transmission target data by using the above-described PUCCH format.

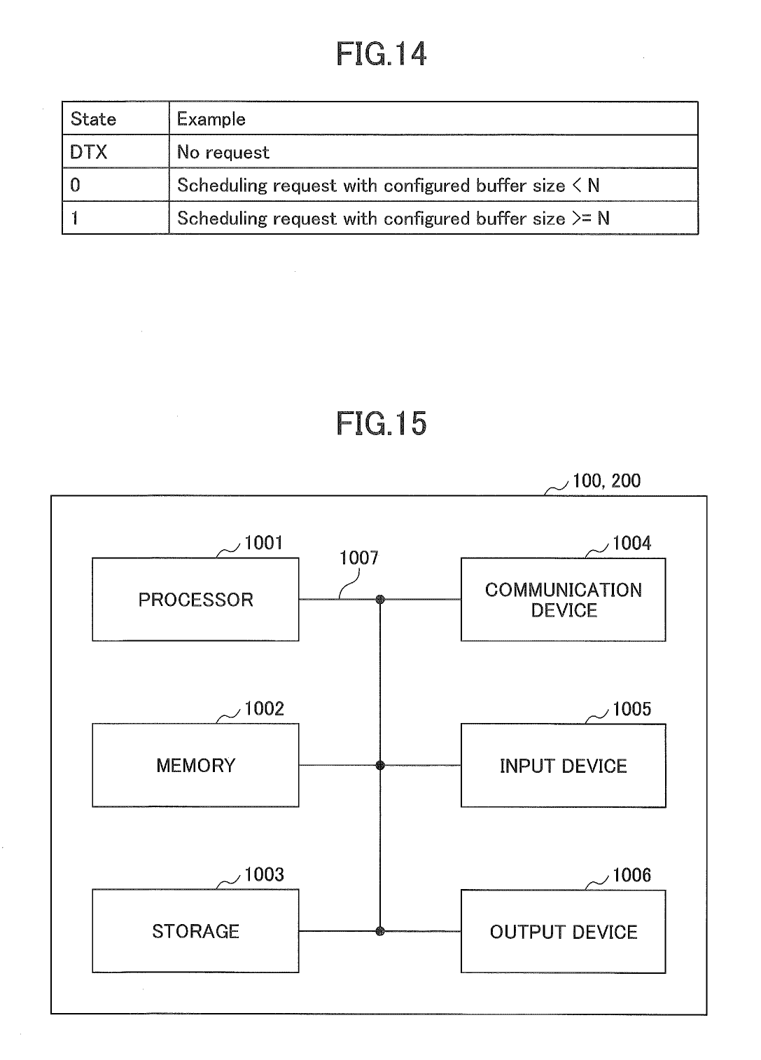

Specifically, the scheduling request transmission unit 130 may transmit a PUCCH format illustrated in FIG. 14 to the base station 200. In the PUCCH format illustrated in FIG. 14, a scheduling request of a bit value of “0” is transmitted in a resource that is allocated for transmission of the scheduling request to indicate that the scheduling request is “scheduling request less than a predetermined buffer size N”, and a scheduling request of a bit value of “1” is transmitted to indicate that the scheduling request is “scheduling request equal to or greater than the predetermined buffer size N”. That is, the scheduling request transmission unit 130 may make a notification of “absence of scheduling request”, “scheduling request less than a predetermined buffer size N”, and “scheduling request equal to or greater than a predetermined buffer size N” in accordance with transmission or non-transmission of the scheduling request and transmission contents in a resource that is set. Here, N may be a parameter that is set by a higher layer, or a parameter that is defined in specifications. In this manner, the user equipment 100 is allowed to transmit the scheduling request in combination with a simplified buffer status report (BSR), and thus the base station 200 can allocate a PUSCH having an appropriate resource size without subsequently receiving the buffer status report. According to this example, the base station 200 can predict a required buffer size, and can allocate a resource that is sufficient in the first uplink grant.

In an example, the scheduling request transmission unit 130 may transmit the scheduling request to the base station 200 with a resource that is associated with a QoS class identifier (QCI). In this case, the base station 200 specifies the QCI that is associated with the resource through which the scheduling request is transmitted, and can perform resource allocation (adjustment or a coding rate, transmission timing of an uplink grant, and the like) in correspondence with the QCI.

Here, the QCI may be associated with traffic characteristics. For example, the traffic characteristics may include a first transmission interval, a minimum packet size, a desired bit rate, a packet delay budget, and a packet error loss rate. For example, the transmission and reception unit 110 makes a notification of the traffic characteristics in association with a bearer/logical channel. For example, the notification may be performed by access signaling (AS) or non-access signaling (NAS). In addition, the QCI or logical channel configuration may include traffic characteristic information. In this manner, the scheduling request transmission unit 130 transmits, to the base station 200, uplink traffic characteristics, and the transmission and reception unit 110 can use a resource, which is allocated to the base station 200, in correspondence with the uplink traffic characteristics.

In the above-described examples, description has been given of a configuration in which the PUCCH signaling of the scheduling request is used for notification of a buffer amount. However, the PUCCH signaling of the transmission plan of the invention is not limited thereto, and may be used, for example, in a D2D communication. In this case, the scheduling request transmission unit 130 transmits, to the base station 200, the scheduling request in the PUCCH, and transmits control information and data, for example, in the physical sidelink control channel (PSCCH) and the physical sidelink shared channel (PSSCH) in accordance with resource allocation from the base station 200. In addition, this example may be executed in combination with the above-described SPS configuration. That is, the scheduling request including the simplified buffer status report may be transmitted in the PUCCH resource in the SPS configuration in combination with a scheduling request resource that is allocated for transmission of the scheduling request. Specifically, the scheduling request transmission unit 130 may transmit a scheduling request including the simplified buffer status report in both of the scheduling request resource and the PUCCH resource in the SPS configuration by using a PUCCH format illustrated in FIG. 14.

Here, the block diagrams for use in the above description of embodiments show blocks for functional units. These functional blocks (components) are implemented in any combination of hardware and/or software items. Also, the implementations of the respective functional blocks are not particularly limited. In other words, the respective functional blocks may be implemented in a physically and/or logically coupled single device or in multiple devices where two or more physically and/or logically separated devices are connected directly and/or indirectly (for example, in wired and/or wireless manners).

For example, the user equipment 100 and the base station 200 according to one embodiment of the present invention may function as a computer processing the radio communication method according to the present invention. FIG. 15 is a block diagram for illustrating a hardware arrangement of the user equipment 100 and the base station 200 according to one embodiment of the present invention. The user equipment 100 and the base station 200 as stated above may each be physically arranged as a computer device including a processor 1001, a memory 1002, a storage 1003, a communication device 1004, an input device 1005, an output device 1006, a bus 1007 or the like.

Note that the language “apparatus” can be interchangeably read as a circuit, a device, a unit or the like. The hardware arrangement of the user equipment 100 and the base station 200 may each be arranged to include one or more of the illustrated devices or without including a part of the devices.

Respective functions in the user equipment 100 and the base station 200 are implemented by loading a predetermined software item (program) into hardware items such as the processor 1001 and the memory 1002 to cause the processor 1001 to execute operations, perform communication with the communication device 1004 and control read and/or write operations on data from/in the memory 1002 and the storage 1003.

The processor 1001 runs an operating system to control the whole computer, for example. The processor 1001 may be arranged with a central processing unit (CPU) including an interface with a peripheral device, a control device, a calculation device, a register and the like. For example, the above-stated components may be implemented in the processor 1001.

Also, the processor 1001 loads programs (program codes), software modules and data from the storage 1003 and/or the communication device 1004 into the memory 1002 and executes various operations in accordance with them. As the programs, programs for causing the computer to perform at least a part of operations as described in the above embodiments are used. For example, operations by the components in the user equipment 100 and the base station 200 may be implemented with control programs stored in the memory 1002 and executed by the processor 1001, and other functional blocks may be similarly implemented. It has been described that the above-stated various operations are performed by the single processor 1001 but they may be performed with two or more processors 1001 simultaneously or sequentially. The processor 1001 may be implemented with one or more chips. Note that the programs may be transmitted from a network via an electric communication line.

The memory 1002 is a computer-readable storage medium and may be arranged with at least one of a ROM (Read Only Memory), an EPROM (Erasable Programmable ROM), an EEPROM (Electrically Erasable Programmable ROM), a RAM (Random Access Memory) or the like, for example. The memory 1002 may be referred to as a register, a cache, a main memory (main storage device) or the like. The memory 1002 can store programs (program codes), software modules or the like that can be executed to implement the radio communication method according to one embodiment of the present invention.

The storage 1003 is a computer-readable storage medium and may be arranged with at least one of an optical disk such as a CD-ROM (Compact Disc ROM), a hard disk drive, a flexible disk, a magnetic optical disk (for example, a compact disk, a digital versatile disk, a Blu-ray (registered trademark) disk), a smart card, a flash memory (for example, a card, a stick, a key drive), a floppy (registered trademark), a magnetic strip or the like. The storage 1003 may be referred to as an auxiliary storage device. The above-stated storage medium may be a database or a server including the memory 1002 and/or the storage 1003 or any other appropriate medium.

The communication device 1004 is a hardware item (transceiver device) for communication over computers via a wired and/or wireless network and may be also referred to as a network device, a network controller, a network card, a communication module or the like. For example, the above-stated components may be implemented in the communication device 1004.

The input device 1005 is an input device for receiving external inputs (for example, a keyboard, a mouse, a microphone, a switch, a button, a sensor or the like). The output device 1006 is an output device for providing external outputs (for example, a display, a speaker, a LED ramp or the like). Note that the input device 1005 and the output device 1006 may be integrally arranged (for example, a touch panel).

Also, the respective devices such as the processor 1001 and the memory 1002 are connected with each other via the bus 1007 for communicating information. The bus 1007 may be arranged with a single bus or different buses for different devices.

Also, the user equipment 100 and the base station 200 may be arranged to include a hardware item such as a macro processor, a digital signal processor (DSP), an ASIC (Application Specific Integrated Circuit), a PLD (Programmable Logic Device), a FPGA (Field Programmable Gate Array) or the like, and a part or all of the functional blocks may be implemented in the hardware item. For example, the processor 1001 may be implemented with at least one of these hardware items.

Transmission of information is not limited to the embodiments/implementations as described in the present specification and may be made in any other manner. For example, information may be transmitted in physical layer signaling (for example, DCI (Downlink Control Information) and UCI (Uplink Control Information)), upper layer signaling (for example, RRC (radio Resource Control) signaling, MAC (medium Access Control) signaling, broadcast information (MIB (master Information Block) and SIB (System Information Block)) or any other signal or combinations thereof. Also, the RRC signaling may be referred to as an RRC message and may be an RRC Connection Setup message, an RRC Connection Reconfiguration message or the like.

The respective embodiments/implementations as described in the present specification may be applied to systems using LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA 2000, UMB (Ultra Mobile Broadband), IEEE 802.11 (Wi-Fi), IEEE 802.16 (WiMAX), IEEE 802.20, UW3 (Ultra-WideBand), Bluetooth (registered trademark) or any other appropriate system or next-generation systems enhanced based on them.

Procedures, sequences, flowcharts or the like of the respective embodiments/implementations as described in the present specification may be permutable, as long as there is not inconsistency. For example, for methods as described in the present specification, various steps are presented in an exemplary order, and the present invention is not limited to the presented certain order.

Certain operations performed by the base station 200 as described in the present specification may be performed by its upper node in some cases. In a network including one or more network nodes having base stations, various operations performed to communicate with terminals may be apparently performed by the base stations and/or network nodes other than the base stations (for example, a MME or an S-SW can be assumed, but the network nodes are not limited to them). Although it has been described that the single network node other than the base stations is used in the above example, combinations of multiple other network nodes (for example, an MME and an S-GW) may be used.

Information and others may be output from an upper layer (or a lower layer) to a lower layer (or an upper layer). They may be input and output via multiple network nodes.

Incoming and outgoing information and others may be stored in a certain location (for example, a memory) and/or managed in a management table. The incoming and outgoing information and others may be overwritten, updated or added. The outgoing information and others may be deleted. The incoming information and others may be transmitted to other device.

Determination may be made with a one-bit value (0 or 1), a Boolean value (true or false) or numerical comparison (for example, comparison with a predetermined value).

The embodiments/implementations as described in the present specification may be used singularly or in combinations or switched in connection with execution. Also, indication of predetermined information (for example, indication “it is X”) is not limited to explicit manners and may be performed implicitly (for example, the predetermined information is not indicated).

Although the present invention has been described in detail, it is apparent to those skilled in the art that the present invention is not limited to the embodiments as described in the present specification. The present invention can be implemented as modifications and variations without departing from the spirit and scope of the present invention as defined in claims. Thus, the description in the present specification is intended for exemplary description and does not mean any restriction to the present invention.

Software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function or the like regardless of the software being referred to as software, a firmware, a middleware, a microcode, a hardware descriptive language or other names.

Also, the software, the instruction or the like may be transmitted and received via a transmission medium. For example, if the software is transmitted from a website, a server or other remote sources by using wired techniques such as a coaxial cable, an optical fiber cable, a twist pair and a digital subscriber line (DSL) and/or wireless techniques such as infrared, radio frequency and microwave, these wired techniques and/or wireless techniques are included within definition of a transmission medium.

Information, signals or the like as described in the present specification may be represented with use of any of various different techniques. For example, data, an instruction, a command, information, a signal, a bit, a symbol, a chip and so on referred to throughout the above description may be represented with a voltage, a current, an electromagnetic wave, a magnetic field, a magnetic particle, an optical field, a photon or any combination thereof.

Note that terminologies described in the present specification and/or terminologies required to understand the present specification may be replaced with terminologies having the same or similar meanings. For example, a channel and/or a symbol may be a signal. Also, the signal may be a message. Also, a component carrier (CC) may be referred to as a carrier frequency, a cell or the like.

The terminologies “system” and “network” for use in the present specification are interchangeably used.

Also, information, a parameter and so on as described in the present specification may be represented with an absolute value, a relative value from a predetermined value or other corresponding information. For example, a radio resource may be specified with an index.

Names as used for the above-stated parameters are not restrictive from any standpoint. Furthermore, there are some cases where formulae and so on using these parameters may be different from ones as explicitly disclosed in the present specification. Various channels (for example, a PUCCH, a PDCCH or the like) and information elements (for example, a TPC or the like) can be identified with any preferred names, and the various names assigned to these various channels and information elements are not restrictive from any standpoint.

A base station can accommodate one or more (for example, three) cells (also referred to as sectors). If the base station accommodates multiple cells, the whole coverage area of the base station can be segmented into multiple smaller areas, and the respective smaller areas can provide communication services with a base station subsystem (for example, indoor small base station RRH: Remote Radio Head). The terminology “cell” or “sector” indicates a part or whole of the coverage area of the base station providing communication services in the coverage and/or the base station subsystem. Furthermore, the terminologies “base station”, “eN5”, “cell” and “sector” can be interchangeably used in the present specification. The base station may be referred to as terminologies such as a fixed station, a NodeB, an eNodeB (eNB), an access point, a femtocell and a small cell.

A mobile station may be referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or any other appropriate terminologies.

There are some cases where terminologies “determining” as used in the present specification may include various operations. The “determining” may include calculating, computing, processing, deriving, investigating, looking up (for example, looking up a table, a database or other data structures) and ascertaining, for example. Also, the “determining” may include receiving (for example, receiving information), transmitting (for example, transmitting information), inputting, outputting and accessing (for example, accessing data in a memory). Also, the “determining” may include resolving, selecting, choosing, establishing, comparing or the like. In other words, the “determining” may include any operation.

The terminologies “connected”, “coupled” or all variations thereof mean direct or indirect connection or coupling between two or more elements and can include existence of one or more intermediate elements between two mutually “connected” or “coupled” elements. The coupling or connection between elements may be physical, logical or in combinations thereof. If they are used in the present specification, it can be considered that two elements are mutually “connected” or “coupled” with use of one or more electric wires, cables and/or print electric connections and as several non-limiting and non-comprehensive examples, with use of electromagnetic energy such as electromagnetic energy having a wavelength of a radio frequency domain, a microwave domain and an optical (both visible and invisible) domain.

A reference signal can be omitted as a RS (Reference Signal) and may be referred to as a pilot depending on applied standards.

The recitation “based on” as used in the present specification does not mean “only based on”, unless specifically stated otherwise. In other words, the recitation “based on” means both “only based on” and “at least based on”.

Any reference to elements with use of terminologies such as “first”, “second” and so on as used in the present specification does not limit the amount or order of these elements in general. These terminologies can be used in the present specification as convenient manners for distinguishing between two or more elements. Accordingly, the reference to the first and second elements does not mean that only the two elements are used there or the first element has to precede the second element in any fashion.

The terminology “means” in an arrangement of each apparatus as stated above may be replaced with “unit”, “circuit”, “device” or the like.

As long as the terminologies “include”, “including” and variations thereof are used in the present specification or claims, these terminologies are intended to be inclusive similar to the terminology “comprising”. Furthermore, the terminology “or” as used in the present specification or claims is intended not to be an exclusive OR.

A radio frame may be arranged with one or more frames in a time domain. In the time domain, one or more frames each may be referred to as a subframe. The subframe may be further arranged with one or more slots in the time domain. The slot may be further arranged with one or more symbols (OFDM symbols, SC-FDMA symbols and so on) in the time domain. Any of the radio frame, the subframe, the slot and the symbol represents a time unit for transmitting signals. The radio frame, the subframe, the slot and the symbol may be referred to in other corresponding manners. For example, in LTE systems, a base station performs scheduling to assign radio resources (frequency bandwidths, transmission power and so on available in the mobile station) to mobile stations. The minimum time unit for scheduling may be referred to as a TTI (Transmission Time Interval). For example, one subframe, multiple contiguous subframes or one slot may be referred to as the TTI. A resource block (RB) may be a resource assignment unit in the time domain and the frequency domain and may include one or more contiguous subcarriers in the frequency domain. Also, in the time domain, the resource block may include one or more symbols and have one slot, one subframe or one TTI in length. The single TTI and subframe each may be arranged with one or more resource blocks. The above-stated arrangement of radio frame is merely exemplary, and the number of subframes in the radio frame, the number of slots in the subframe, the number of symbols and resource blocks in the slot and the number of subcarriers in the resource block can be changed in any manner.

Although the embodiments of the present invention have been described in detail, the present invention is not limited to the above-stated specific embodiments, and various modifications and variations can be made within the spirit of the present invention as recited in claims.

The present application is based on and claims the benefit of priority of Japanese Priority Application No. 2016-073456 filed on Mar. 31, 2016, the entire contents of which are hereby incorporated by reference.

### EXPLANATIONS OF LETTERS OR NUMERALS

10: Radio communication system
100: User equipment
110: Transmission and reception unit
120: Transmission plan notification unit
130: Scheduling request transmission unit
200: Base station

1. A user equipment, comprising:
a transmission and reception unit that transmits and receives a radio signal to and from a base station; and
a transmission plan notification unit that transmits, to the base station, an uplink data transmission plan related to a semi-persistent scheduling (SPS) configuration.

2. The user equipment according to claim 1, wherein the transmission plan notification unit transmits the transmission plan by a physical uplink control channel (PUCCH) before transmission timing of the uplink data.

3. The user equipment according to claim 1, wherein the transmission plan includes one or more among “absence of transmission target data”, “presence of transmission target data”, “size of transmission target data”, and “offset of transmission timing”.

4. The user equipment according to claim 3, wherein the transmission plan notification unit transmits any one or more among “absence of transmission target data”, “presence of transmission target data”, “size of transmission target data”, and “offset of transmission timing” in accordance with transmission or non-transmission of the PUCCH that is set and/or transmission contents.

5. A user equipment, comprising:
a transmission and reception unit that transmits and receives a radio signal to and from a base station; and
a scheduling request transmission unit that transmits a scheduling request to the base station in combination with a size of transmission target data.

6. The user equipment according to claim 5, wherein the size of the transmission target data includes “the transmission target data is less than a predetermined size”, or “the transmission target data is equal to or greater than the predetermined size”.

7. The user equipment according to claim 5, wherein the scheduling request transmission unit transmits the scheduling request to the base station with a resource that is associated with a QoS class identifier (QCI).

8. The user equipment according to claim 5,
wherein the scheduling request transmission unit transmits, to the base station, uplink traffic characteristics, and
the transmission and reception unit uses a resource that is allocated by the base station in correspondence with the uplink traffic characteristics.

9. The user equipment according to claim 2, wherein the transmission plan includes one or more among “absence of transmission target data”, “presence of transmission target data”, “size of transmission target data”, and “offset of transmission timing”.

10. The user equipment according to claim 6, wherein the scheduling request transmission unit transmits the scheduling request to the base station with a resource that is associated with a QoS class identifier (QCI).

11. The user equipment according to claim 6,
wherein the scheduling request transmission unit transmits, to the base station, uplink traffic characteristics, and
the transmission and reception unit uses a resource that is allocated by the base station in correspondence with the uplink traffic characteristics.

12. The user equipment according to claim 7,
wherein the scheduling request transmission unit transmits, to the base station, uplink traffic characteristics, and
the transmission and reception unit uses a resource that is allocated by the base station in correspondence with the uplink traffic characteristics.
